(19) United States
(12) Patent Application Publication
(10) Pub. No.: US 2023/0119373 A1
(43) Pub. Date: Apr. 20, 2023

(54) WINDOW BLIND MOUNTING SYSTEM

(71) Applicants: Tser Wen Chou, Yorba Linda, CA (US); Mason Chou, Irvine, CA (US)

(72) Inventor: Tser Wen Chou, Yorba Linda, CA (US)

(21) Appl. No.: 17/576,133

(22) Filed: Jan. 14, 2022

(30) Foreign Application Priority Data
Oct. 15, 2021 (TW) 110212167
Nov. 16, 2021 (TW) 110213505

(51) Int. Cl. F16M 13/02; E06B 9/38

(52) U.S. Cl. CPC F16M 13/02; E06B 9/38

(57) ABSTRACT

A mounting system for window blinds is provided. The mounting system provides components that can be used to mount a window blind or shade. The components of the mounting system include support brackets, mounting clips, railing devices, adjustable arms, spacers, etc. These components can be provided in different combinations to mount different types of blinds or shades to walls or ceilings, regardless of whether the wall to be mounted to is above, behind, or to the sides of the window blind.

### CROSS REFERENCE TO RELATED APPLICATIONS

This patent application claims the benefit and priority of Taiwanese Patent Applications No. 110212167, filed on Oct. 15, 2021, and No. 110213505, filed on Nov. 16, 2021. Taiwanese patent applications No. 110212167 and No. 110213505 are incorporated herein by reference.

### BACKGROUND

### Technical Field

The present disclosure generally relates to mechanisms and components for mounting window blinds or shades.

### Description of the Related Arts

The installation of a window blind or shade system often involves using two or more box brackets to support the weight of the installed window blind or shade. The box brackets are mounted to a wall or ceiling surface near the window, and a headpiece of the blind or shading system is placed into the box bracket, which then closes to hold the blind system in place. A box bracket has two large metallic pieces, which sometimes cause box brackets to become scarce and pricey commodities.

### SUMMARY

Some embodiments of the invention provide a mounting system for window blinds. The mounting system provides components that can be used to mount a window blind or shade. The components of the mounting system include support brackets, mounting clips, railing devices, adjustable arms, spacers, etc. These components can be provided in different combinations to mount different types of blinds or shades to walls or ceilings, regardless of whether the wall to be mounted to is above, behind, or to the sides of the window blind.

In some embodiments, the system provides a flex bracket and a railing device. The flex bracket is C-shaped and has a top plate, a middle plate, and a bottom plate that are configured to form an embrace for supporting a headpiece casing of the window blind and is configured to be mounted to a wall surface. The flex bracket can be mounted to the wall through the top plate or the middle plate. The railing device is configured to constrain the headpiece casing to the flex bracket. The railing device has first and second top rails that are T-shaped and form a recess cavity that is configured to mate with the top plate of the flex bracket. In some embodiments, the railing device has first and second bottom rails that are configured to abut exterior surfaces of the headpiece casing. In some embodiments, the railing device has first and second bottom rails that are configured to abut interior surfaces of the headpiece casing. The headpiece casing may have curling lips, and the first and second bottom rails are J-shaped and are configured to hook onto the curling lips.

In some embodiments, the mounting system provides a railing device and a mounting clip. The railing device has first and second top rails and first and second bottom rails. The mounting clip is configured to mount to a surface of a wall or ceiling. The mounting clip is configured to snap onto the first and second top rails of the railing device. The first and second bottom rails are configured to constrain a headpiece casing of the window blind. In some embodiments, the first and second top rails are T-shaped with flanges that snap into the mounting clip. The first and second bottom rails are J-shaped and configured to abut interior surfaces of a headpiece casing of the window blind. The headpiece casing may have curling lips, and the first and second bottom rails are J-shaped and configured to hook onto the curling lips. The first bottom rail may also be configured to latch a component of the window blind. In some embodiments, the railing device has a third bottom rail that is T-shaped and is configured to latch a holder bracket for supporting a roller of different type of window blinds. The railing device may be one of two or more railing segments that are configured to slide along the headpiece casing to match a position of the mounting clip. The railing device may also be a headrail having a length that is at least half of that of the headpiece casing and support the entire window blind. In some embodiments, a flex bracket is fastened to an end of the headpiece casing and to mate with the railing device. The flex bracket is C-shaped and has a top plate that is configured to mate with the railing device. The first and second bottom rails are configured to abut exterior surfaces of the headpiece casing, and the first and second top rails of the railing device form a recess cavity that is configured to mate with the flex bracket.

In some embodiments, the system provides the flex bracket and an adjustable arm. The adjustable arm is configured to constrain the headpiece casing to the flex bracket. The adjustable arm is fastened to the top plate of the flex bracket through a slipping groove that allows the adjustable arm to extend, retract, and swivel. The adjustable arm is allowed to swivel to a first position that is perpendicular to the middle plate and a second position that is parallel to the middle plate. The adjustable arm may swivel to the perpendicular position when the flex bracket is mounted to a wall surface behind the headpiece casing. The adjustable arm may swivel to the parallel position when the flex bracket is mounted to a wall surface to a side of the headpiece casing. In some embodiments, the system also provides a spacer that is configured to mate with the flex bracket and to provide a spacing between the flex bracket and a second wall surface. The spacer has a first recess cavity configured to recess the top plate of the flex bracket and a second recess cavity configured to recess the adjustable arm when the adjustable arm is at a position perpendicular to the middle plate.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subject matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates the components of a window blind mounting system, consistent with an exemplary embodiment.

FIGS. 2A-B illustrate mounting a support bracket.

FIGS. 3A-D show an adjustable arm and a railing segment that are used to secure a headpiece of a window blind to a support bracket.

FIGS. 4A-D show an adjustable arm and a spacer that are used to secure a headpiece of a window blind to the support bracket.

FIGS. 5A-D illustrate mounting the window blind to walls at the sides of the window blind.

FIGS. 6A-D illustrate mounting the window blind to a wall behind the window blind.

FIG. 7 illustrates a cross section view of the support bracket being mounted to the wall or ceiling above the window shade.

FIG. 8 illustrates an installed headpiece with support brackets and adjustable arms.

FIGS. 9A-B illustrate the mounting of a window blind using railing segment with fixed side rails.

FIGS. 10A-C illustrate using a railing segment with bottom rails and top rails to constrain or secure a headpiece to a support bracket.

FIGS. 11A-C illustrate a railing segment that constrains the headpiece to the support bracket by having bottom rails that abut the exterior surface of a headpiece casing.

FIGS. 12A-C illustrate using spacers having two arms to affix a headpiece to a support bracket.

FIGS. 13A-C illustrate using mounting clips and railing segments to mount a window blind.

FIGS. 14A-B illustrate railing segments fastened to a headpiece casing for mounting the window blind with mounting clips.

FIGS. 15A-B illustrate using support brackets that are fastened to a headpiece casing to install a window blind to mounting clips.

FIGS. 16A-C illustrate a headrail that is used to mount a window blind.

FIGS. 17A-B illustrate latching taps latching onto a J-shaped bottom rail for installing a façade.

FIGS. 18A-B illustrate the T-shaped supplemental bottom rail and the J-shaped bottom rail being used jointly to install a Roman shade.

FIGS. 19A-B illustrate a J-shaped bottom rail being used to latch one end of a window blind while holder brackets support a roller of the window blind.

FIGS. 20A-B illustrate the J-shaped bottom rail being used to hang a window blind without a headpiece.

FIGS. 21A-B illustrate both J-shaped bottom rails of the headrail being used to hang window blinds.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Some embodiments of the invention provide a mounting system for window blinds. The mounting system includes components that can be used to mount a window blind or shade. The components of the mounting system include support brackets, mounting clips, railing devices, adjustable arms, spacers, etc. These components can be provided in different combinations to mount different types of blinds or shades to walls, regardless of whether the wall is above, behind, or to the sides of the window blind, for both inside mount (inside a window frame) and outside mount (outside a window frame).

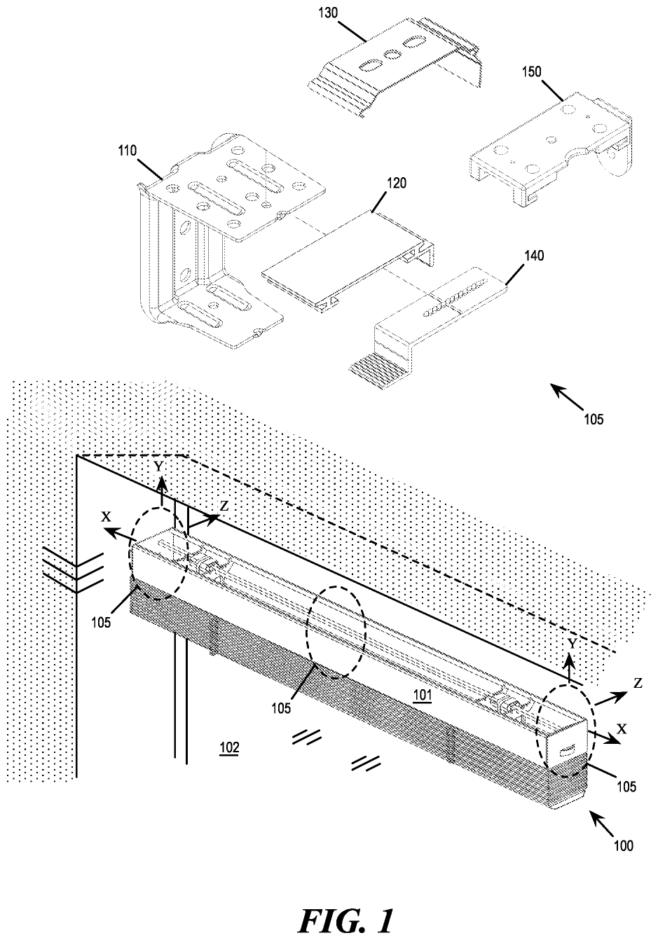

FIG. 1 illustrates the components of a window blind mounting system 105, consistent with an exemplary embodiment. The figure conceptually illustrates a window blind 100 being installed for a window 102 by using the window blind mounting system 105. The window blind 100 comprises a headpiece 101, which may include a roller or a casing for cords or other control mechanisms of the window blind 100.

The window blind mounting system 105 may be implemented by components such as a support bracket 110, a railing segment 120, a mounting clip 130, an adjustable arm 140, a spacer 150, among others that are not illustrated. A combination of one or more of these components may be used to mount the window blind 105 to the wall behind the blind (Z-direction), or to the wall to the left and right of the blind (X-direction), or to the wall or ceiling above the blind (Y-direction).

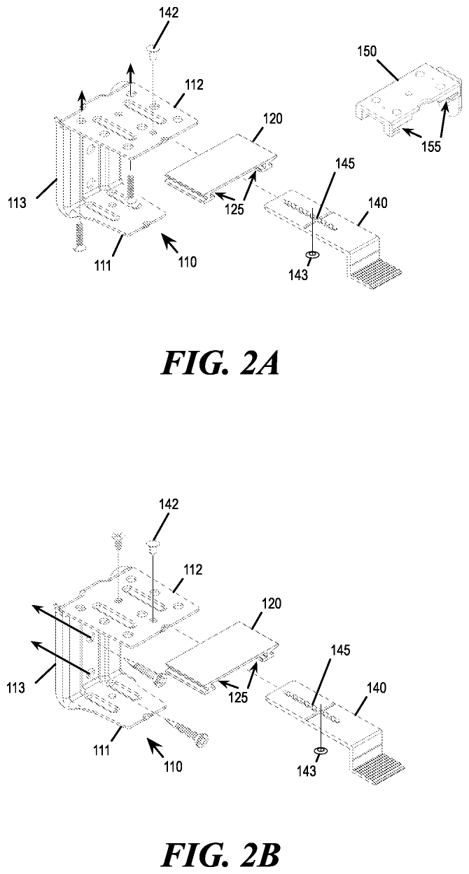

FIGS. 2A-B illustrate the mounting of a support bracket. As illustrated, the support bracket 110 (also referred to as flex bracket) has a C-shaped or a tipped-over U-shaped structure that includes three sections: a bottom plate 111, a top plate 112, and a middle plate 113. The three plates form an embrace for a headpiece of a window blind. The bottom plate 111 is configured to support the weight of the window blind. The top plate 112 is configured to mate with a recess cavity 125 in the railing segment 120 (or a recess cavity 155 in the spacer 150) for securing the headpiece 101 of the window blind 100 to the support bracket 110. The adjustable arm 140 is attached to the top plate 112 by a rivet 142 and a washer 143 through a slipping groove 145 so the adjustable arm 140 can swivel to different orientation and can extend or retract.

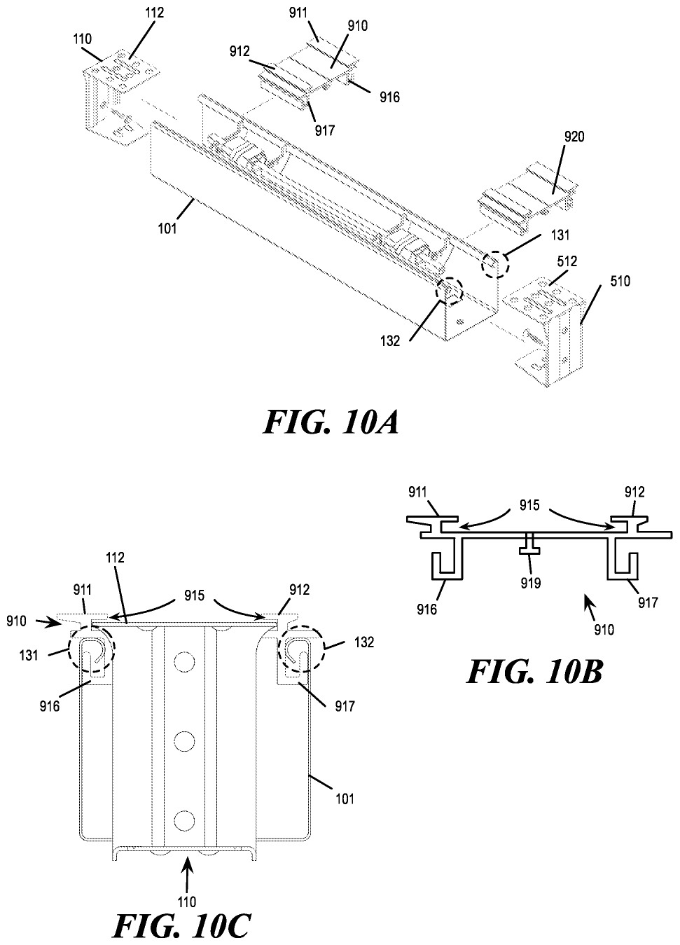

A railing segment such as the railing segment 120 is a segment of a railing device. A railing device is typically made of material that can support the weight of a window blind system, such as aluminum or another type of metal. A railing device may have one or more rail or beam formations that runs along its top surface and bottom surface. A railing device may be a headrail that support the entire window blind. Such a headrail may have a length that is at least half of that of the headpiece. A railing device may also be a segment thereof (hence referred to as a railing segment) whose length is a fraction of the length of the headpiece of the window blind. Two or more railing segments may be required to support the window blind. Examples of different railing devices will be described by reference to FIGS. 10, 11, and 16 below.

Fasteners can be applied to the top plate 112 to mount the support bracket to a wall or ceiling above the window blind, or to the middle plate 113 to mount the support bracket to a wall at a side or rear of the window blind. FIG. 2A shows the top plate 112 being used to mount the support bracket to a wall surface above. FIG. 2B shows the middle plate 113 being used to mount the support bracket 110 to a wall surface at the left (or the right or the rear.)

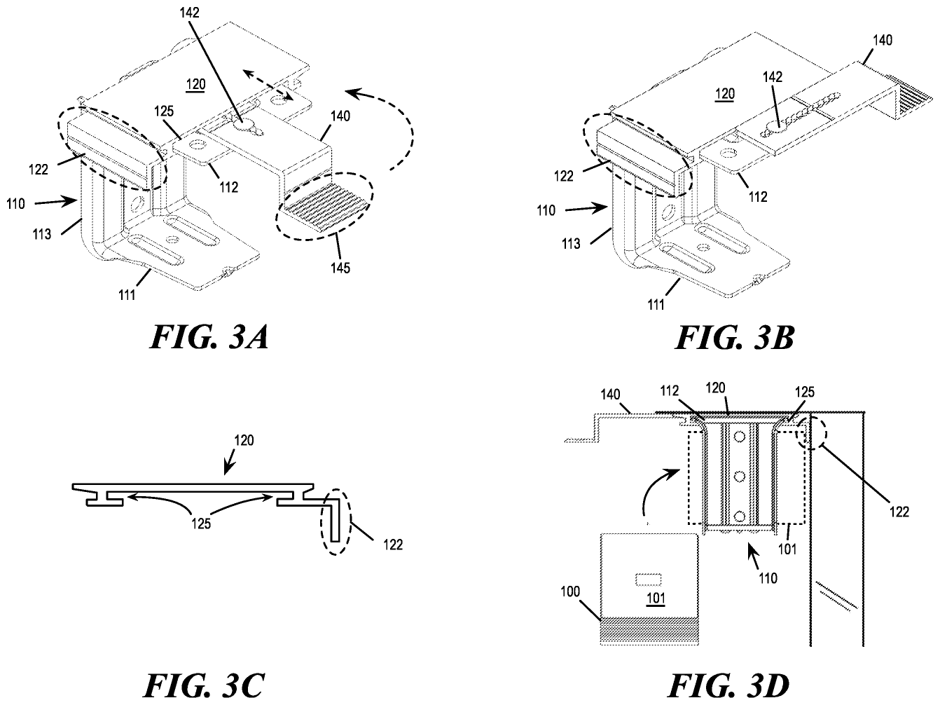

FIGS. 3A-D show an adjustable arm and a railing segment that are used to constrain or secure a headpiece of a window blind to a support bracket. The position of the adjustable arm 140 is adjustable to accommodate the width of the headpiece 101. The adjustable arm 140 can also swivel to accommodate different mounting orientations of the support bracket 110. FIG. 3A shows the adjustable arm in a position that is perpendicular to the middle plate 113. FIG. 3B shows the adjustable arm in a position that is parallel to the middle plate 113. The adjustable arm 140 has a handling tap 145 that protrudes out but can be cut off or shorn off after the installation is complete.

FIG. 3C illustrates a side elevation view of the railing segment 120. As illustrated, the railing segment 120 has a cavity 125 and an optional L-shaped arm 122. The optional arm 122 can be used, jointly with the adjustable arm 140, to constrain or guide the headpiece 101 to a desired position. The optional arm 122 of the railing segment 120 may also be used to guarantee spacing between the mount assembly (based on the support bracket 110) and the wall. FIG. 3D illustrates a side elevation view of the support bracket when the optional arm of the railing segment 120 is used to provide spacing with the wall and for securing the headpiece 101 of the window blind 100. The figure also illustrates the cavity 125 of the railing segment 120 being used to recess or mate with the top plate 112.

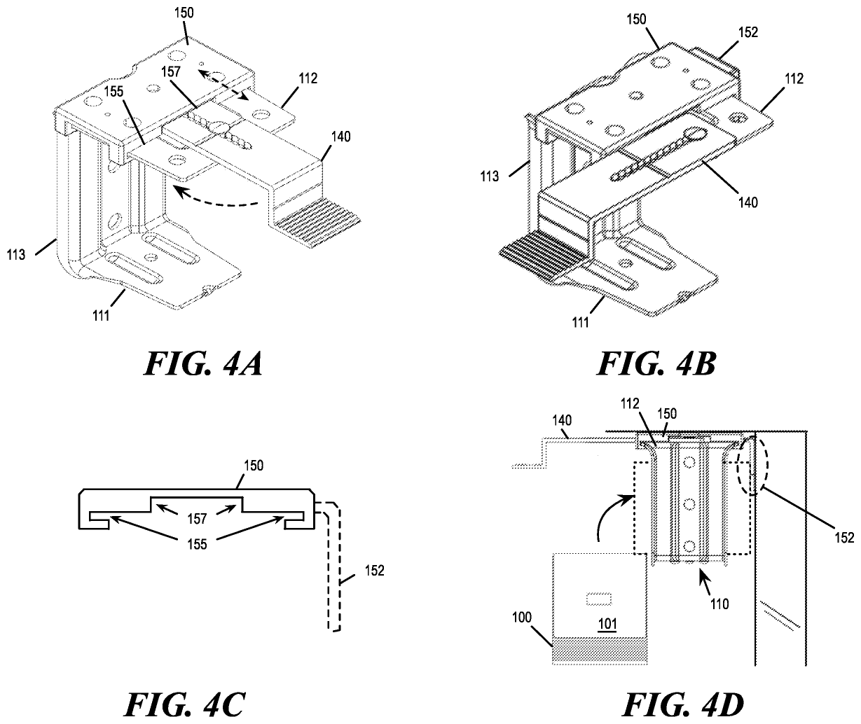

The railing segment 120 is a headrail segment that functions as a spacer. A spacer such as the railing segment 120 or the spacer 150 can move along the top plate 112 to lockdown or release the angular position of the adjustable arm 140. FIGS. 4A-D show an adjustable arm and a spacer that are used to constrain a headpiece of a window blind to the support bracket. FIG. 4A shows the adjustable arm 140 in a perpendicular position (that is perpendicular to the middle plate 113). FIG. 4B shows the adjustable arm in a parallel position (that is parallel to the middle plate 113).

The spacer 160 has a cavity 155 for recessing the top plate 112. The spacer 150 also has an additional cavity 157 for recessing the adjustable arm 140 when the adjustable arm 140 is in the perpendicular position (as shown in e.g., FIG. 4A). FIG. 4C illustrates a side elevation view of the spacer 150 with the cavity 155 and the cavity 157. The spacer 150 has an optional arm 152 that can be used, jointly with the adjustable arm 140, to constrain or guide the headpiece 101 to a desired position. The optional arm 152 of the spacer 150 may also be used to guarantee spacing between the mount assembly (based on the support bracket 110) and the wall. FIG. 4D illustrates a side elevation view of the support bracket when the optional arm of the spacer is used to provide spacing with the wall. The figure also illustrates the cavity 155 of the railing segment 120 being used to recess or mate with the top plate 112.

In some embodiments, the spacer 150 and the adjustable arm 140 are manufactured from lighter or more flexible material than the support bracket 110. For example, the support bracket 110 may be metallic (e.g., aluminum) while the spacer 150 and the adjustable arm 140 may be plastic. This is because the support bracket 110 is configured to support the weight of the window blind while the spacer 150 and the adjustable arm are configured to constrain the headpiece to the support bracket 110 but not configured to support the weight of the window blind 110.

As mentioned, the adjustable arm 140 can rotate or swivel to accommodate different mounting positions. For example, the adjustable arm may swivel to the perpendicular position when the support bracket is mounted to a wall surface behind the headpiece casing, and may swivel to the parallel position when the support bracket is mounted to a wall surface to a side of the headpiece casing.

The adjustable arm 140 can extend to receive the headpiece 101 into the embrace of the support bracket 110. After the blind headpiece is in place, the adjustable arm can retract to hold the headpiece in place and to conform to the width of the headpiece. In other words, the adjustable arm 140 can adapt to the dimension of the headpiece and to the installation environment of the blind.

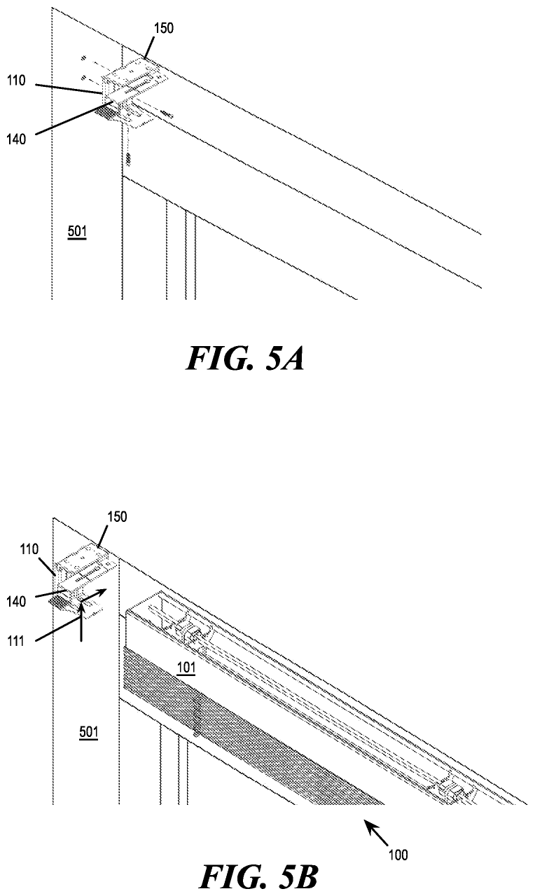

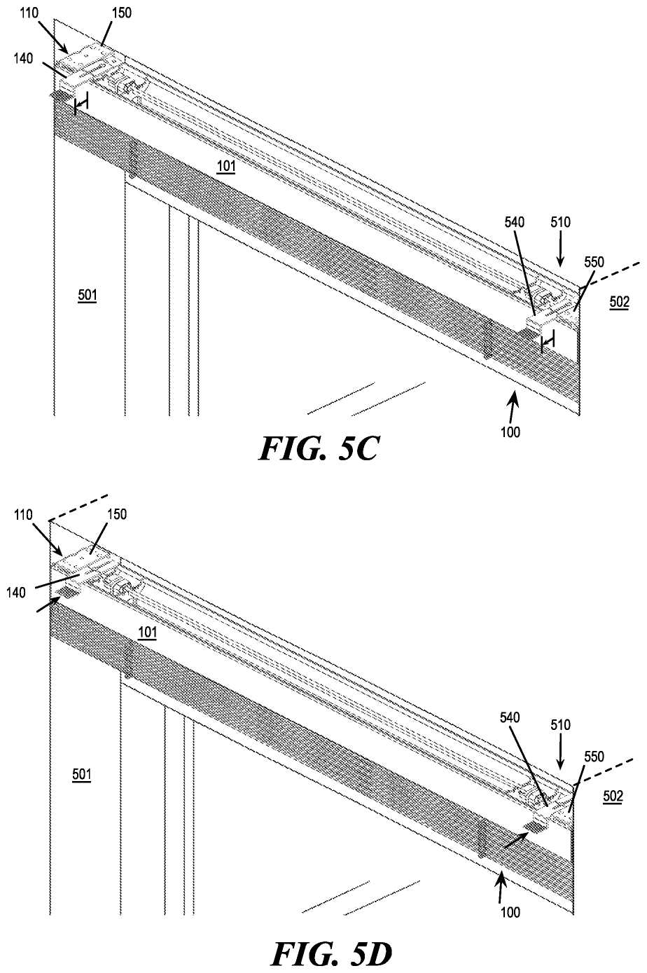

FIGS. 5A-D illustrate mounting the window blind to walls at the sides of the window blind during inside mounting (the window blind is mounted inside a window frame.) FIG. 5A shows mounting the support bracket 110 to the wall 501 at the left of window blind to be installed (X-direction). The adjustable arm 140 swivels to the parallel position and is assembled with the spacer 150. FIG. 5B shows the window blind 100 being raised toward the support bracket 110, and the adjustable arm 140 in an extended position to receive the headpiece 101 into the embrace of the support bracket 110. FIG. 5C shows the headpiece 101 in the embrace of the support bracket 110, with the adjustable arm 140 in its extended position. FIG. 5D shows the adjustable arm 140 retracted to constrain the headpiece 101 to the support bracket 110.

Another support bracket 510 is supporting the right end of the headpiece 101. The support bracket 510 is assembled with an adjustable arm 540 and a spacer 550. The support bracket 510, the adjustable arm 540, and the spacer 550 are identical to and interchangeable with the support bracket 110, the adjustable arm 140, and the spacer 150, respectively, and serve analogous functions at the right end. Here, the support bracket 510 is mounted to a wall 502 to the right of the window blind to be installed (X-direction), and the adjustable arm 540 swivels to the parallel position (parallel to the spacer 550).

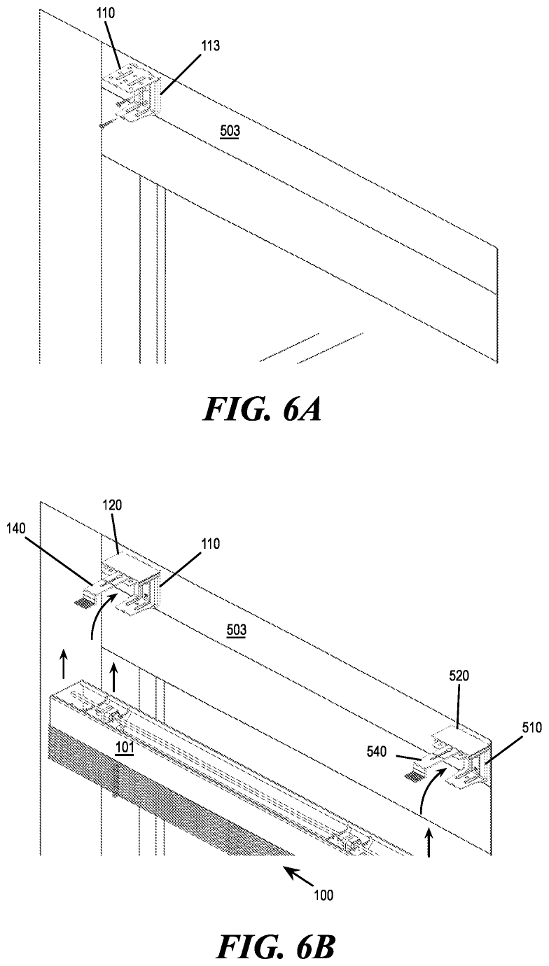

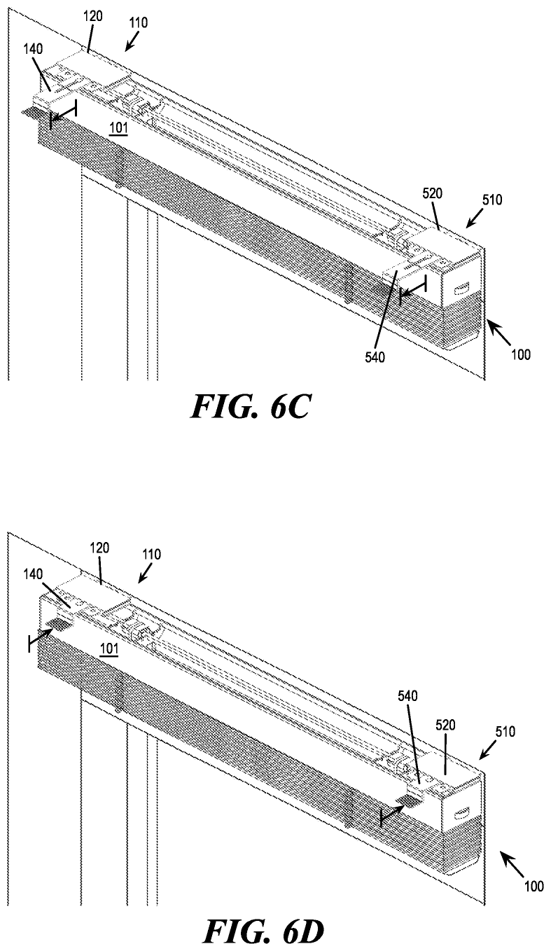

FIGS. 6A-D illustrate mounting the window blind to a wall behind the window blind. The wall being mounted may be outside a window frame (outside mount) or inside a window frame (inside mount). FIG. 6A shows mounting the support bracket 110 to the wall 503, which is behind the window blind 100 to be installed (Z-direction). The adjustable arm 140 swivels to the perpendicular position and is assembled with the railing segment 120, which serve similar role in the mounting assembly as the spacer 150. FIG. 6B shows the window blind 100 being raised toward the support bracket 110, and the adjustable arm 140 is in an extended position to receive the headpiece 101 into the embrace of the support bracket 110. FIG. 6C shows the headpiece 101 in the embrace of the support bracket 110. The support bracket 110 is holding the left end of the headpiece 101, and the adjustable arm 140 is still in its extended position. FIG. 6D shows the adjustable arm 140 retracted to constrain or secure the headpiece 101 to the support bracket 110. The other support bracket 510 is also mounted to the wall 503 behind the window blind to be installed (Z-direction), and the adjustable arm 540 swivels to the perpendicular position.

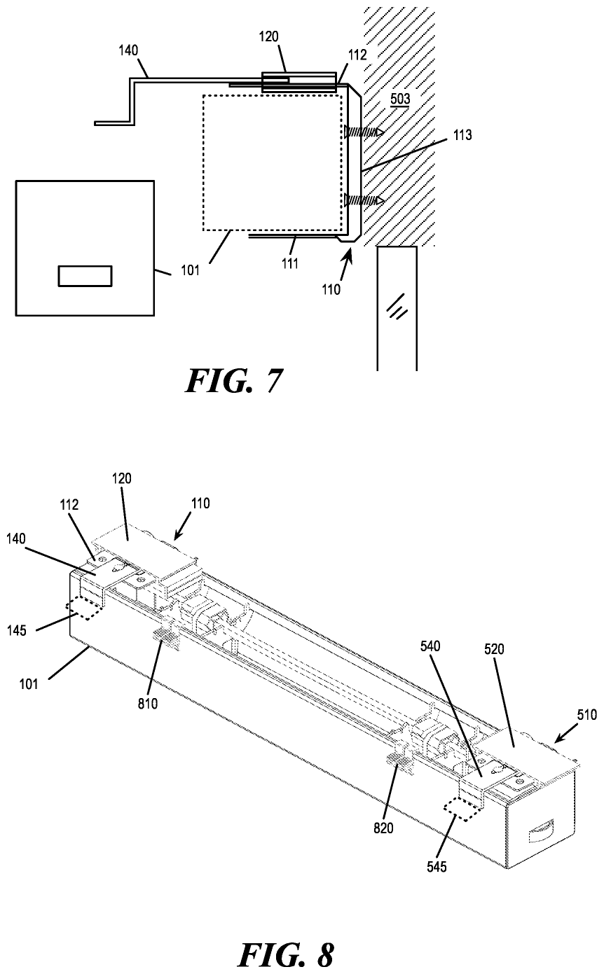

The examples of FIGS. 5A-D and FIGS. 6A-D illustrate examples in which the support bracket 110 is mounted to the walls in the X-direction (left or right) or Z-direction (rear). However, as discuss above by reference to FIG. 2A, the support bracket 110 can also be mounted to the walls in the Y direction (above). In these instances, the adjustable arm 140 can still swivel in the perpendicular or parallel position, and still extend/retract to hold the headpiece of the window blind in place. FIG. 7 illustrates a cross section view of the support bracket 110 being mounted to the wall 503 behind the window shade (Z-direction). The wall 503 may be outside a window frame (outside mount) or inside a window frame (inside mount.) The support bracket 110 is mounted through its middle plate 113. The adjustable arm 140 is at the perpendicular position and is extended to allow the headpiece 101 to be installed. The headpiece 101 will be constrained to its desired position by the adjustable arm 140 and the middle plate 113 of the support bracket 110.

FIG. 8 illustrates an installed headpiece with support brackets and adjustable arms. The two ends of the headpiece 101 are supported by the supporting bracket 110 and 510 and are held in place by the adjustable arms 140 and 540, which are in their perpendicular positions. The handling taps 145 and 545 of the adjustable arms 140 and 540 have been removed. The mounting system 105 may provide additional components for supporting other parts of the installed window blind. For example, optional support clips 810 and 820 can be attached to the headpiece 101 to support an ornamental façade for the blind.

In embodiments described by reference to FIGS. 2-8, the adjustable arm 140 adapt to the shape and dimension of the headpiece by extending to receive the headpiece and retracting to constrain or secure the headpiece at the support bracket 110. In some other embodiments, the adjustable arm 140 is not used, and a railing segment having fixed bottom rails (or a spacer with fixed arms) is used to constrain the headpiece of the window blind. Specifically, the railing segment has a recess cavity to receive the top plate 112 of the support bracket and two bottom rails to hold the headpiece in place.

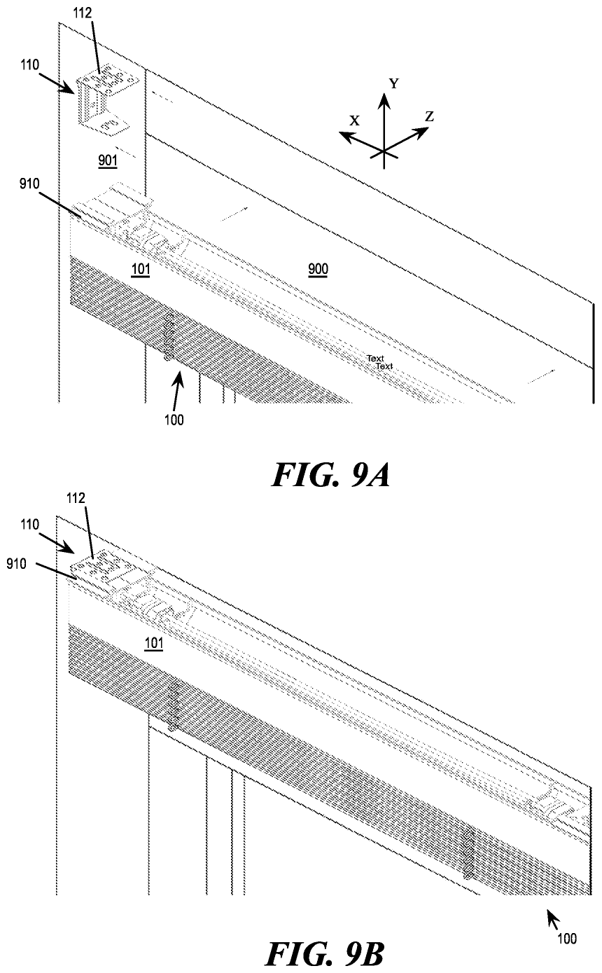

FIGS. 9A-B illustrate the mounting of a window blind using railing segment with fixed side rails. FIG. 9A shows the support bracket 110 is mounted to a wall surface 901. A railing segment 910 having two bottom rails is placed over the headpiece 101 of the window blind 100. The two bottom rails limit the movement of headrail 101 and the railing segment 910 relative to each other. The railing segment 910 also has two top rails that forms a recess cavity for receiving the top plate 112 of the support bracket.

FIG. 9B shows a headpiece 101 being placed into the embrace of the support bracket 110. Thus, the position of the headpiece 101 in the Y-direction (up and down) and in the X-direction (left and right) is fixed by the support bracket 110. The top plate 112 of the support bracket 110 is inserted into the recess cavity of the railing segment 910. Thus, the movement of the headpiece 101 in the Z-direction (toward or away from the window 900) is also fixed by the railing segment and its bottom rails.

FIGS. 10A-C illustrate using a railing segment with bottom rails and top rails to constrain or secure a headpiece to a support bracket. FIG. 10A shows the railing segments and the support brackets used to mount a window blind in a perspective view. The railing segment 910 is used to affix the left end of the headpiece 101 to the support bracket 110, while another railing segment 920 is used to affix the right end of the headpiece 101 to the support bracket 510. The railing segments 910 and 920 are identical or similar parts. The railing segment 910 has two top rails 911 and 912 and two bottom rails 916 and 917. FIG. 10B shows a cross section view of the railing segment 910. As illustrated, the two top rails 911 and 912 are T-shaped and form a recess cavity 915. The two bottom rails 916 and 917 are J-shaped and positioned to match the internal dimension of the headpiece 101. FIG. 10C shows a side elevation view of the railing segment 910 and the support bracket 110 after the headpiece 101 is installed. As illustrated, the top plate 112 is inserted into the recess cavity 915 formed by the two top rails 911 and 912. The two bottom rails 916 and 917 abuts the interior surfaces of the headpiece 101 to hold the headpiece 101 in place.

The casing of the headpiece 101 has lips 131 and 132 that curls inward. In some embodiments, the J-shaped bottom rails 916 and 917 of the railing segment 910 are configured to hook on to the curling lips 131 and 132. In some embodiments, the railing segment 910 may have other features such as a T-shaped supplemental bottom rail 919 under the railing segment 910. Such a supplemental bottom rail may be used to mate with certain support structures of a window blind.

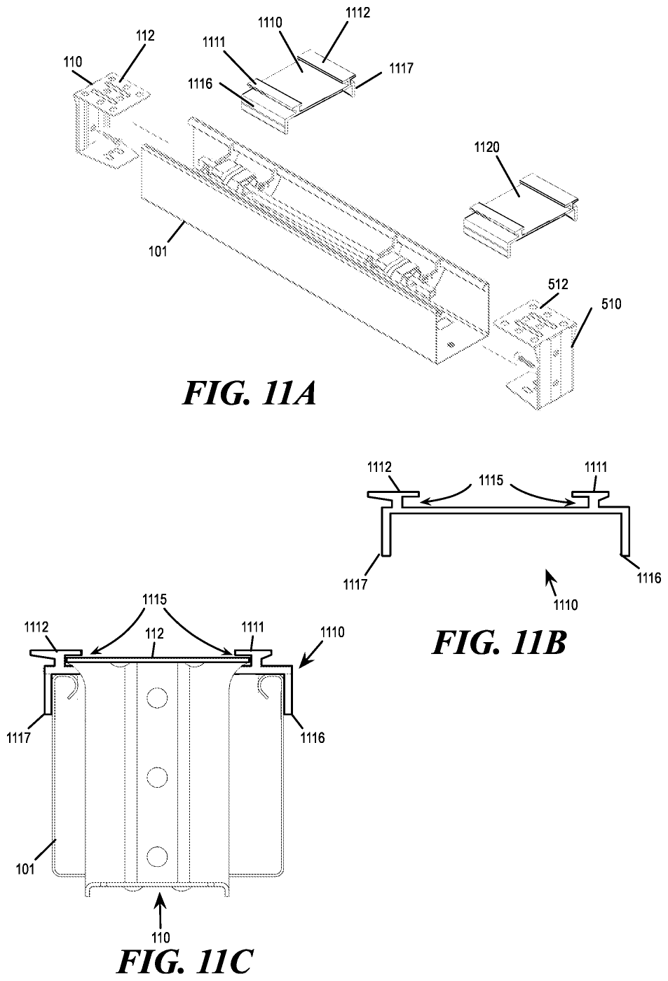

A railing segment used for affixing the headpiece may have a different shape than the railing segment 910. For example, in some embodiments, the railing segment may have bottom rails that are configured to abut the exterior surface of the headpiece rather than the interior surface. FIGS. 11A-C illustrate a railing segment that constrains the headpiece to the support bracket by having bottom rails that abut the exterior surface of a headpiece casing.

FIG. 11A shows the railing segments and the support brackets used to mount a window blind in a perspective view. The railing segment 1110 is used to affix the left end of the headpiece 101 to the support bracket 110, while another railing segment 1120 is used to affix the right end of the headpiece 101 to the support bracket 510. The railing segments 1110 and 1120 are identical or similar parts. The railing segment 1110 has two top rails 1111 and 1112 and two bottom rails 1116 and 1117. FIG. 11B shows the railing segment 1110 having bottom rails 1116 and 1117 that are configured to abut the exterior surface of the headpiece 101. The railing segment 1110 has two top rails 1111 and 1112 that forms a recess cavity 1115 that is configured to receive the top plate 112. FIG. 11C shows the headpiece 101 being embraced by the support bracket 110 and the top plate 112 is inserted into the recess cavity 1115. The support bracket 110 therefore affixes the rail segment 1110, whose bottom rails 1116 and 1117 in turn affix the headpiece 101 by abutting its exterior surfaces.

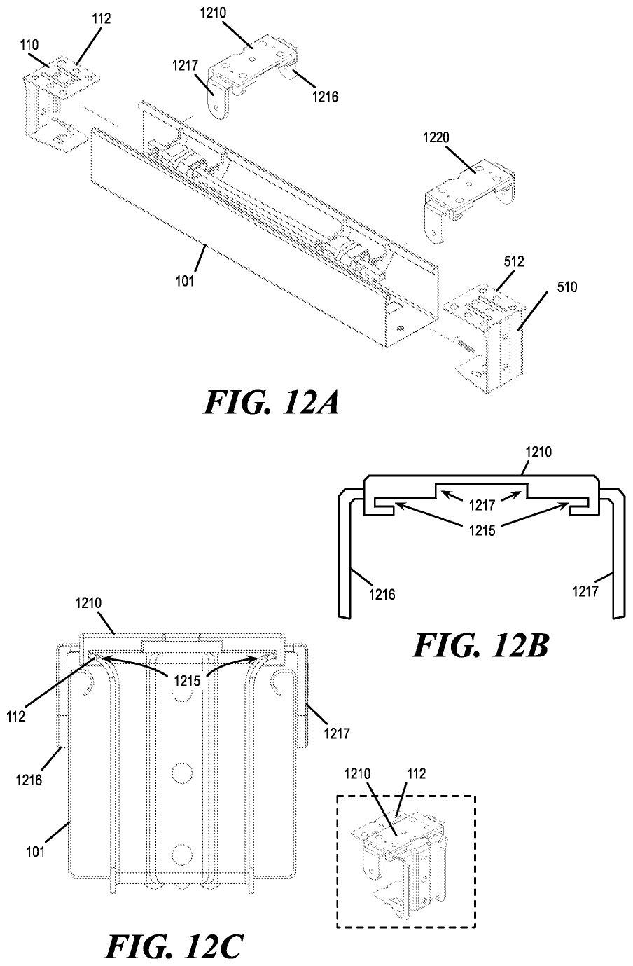

In some embodiments, a spacer with two arms that abuts the exterior surface of the headpiece is used to constrain the headpiece to the support bracket. FIGS. 12A-C illustrate using spacers having two arms to affix a headpiece to a support bracket. FIG. 12A shows spacers and support brackets being used to mount a window blind in a perspective view. A spacer 1210 is used to affix the left end of the headpiece 101 to the support bracket 110, while another spacer 1220 is used to affix the right end of the headpiece 101 to the support bracket 510. FIG. 12B shows a cross section view of the spacer 1210, which has two arms 1216 and 1217. The two arms 1216 and 1217 are configured to abut the exterior surface of the headpiece 101. The spacer 1210 also has a recess cavity 1215 that is configured to receive the top plate 112 of the support bracket 110. In some embodiments, the spacers 1210 and 1220 are replicate parts of the spacer 150 (except that spacer 1210 and 1220 each has two arms). For example, the spacer 1210 has a first recess cavity 1215 that is identical to the recess cavity 155 and a recess cavity 1217 that is identical to the recess cavity 157. FIG. 12C shows a side elevation view of the spacer 1210 and the support bracket 110 after the headpiece 101 is installed. As illustrated, the top plate 112 of the support bracket 110 is inserted into the recess cavity 1215. The two spacer arms 1216 and 1217 abuts the exterior surfaces of the headpiece 101 to hold the headpiece 101 in place.

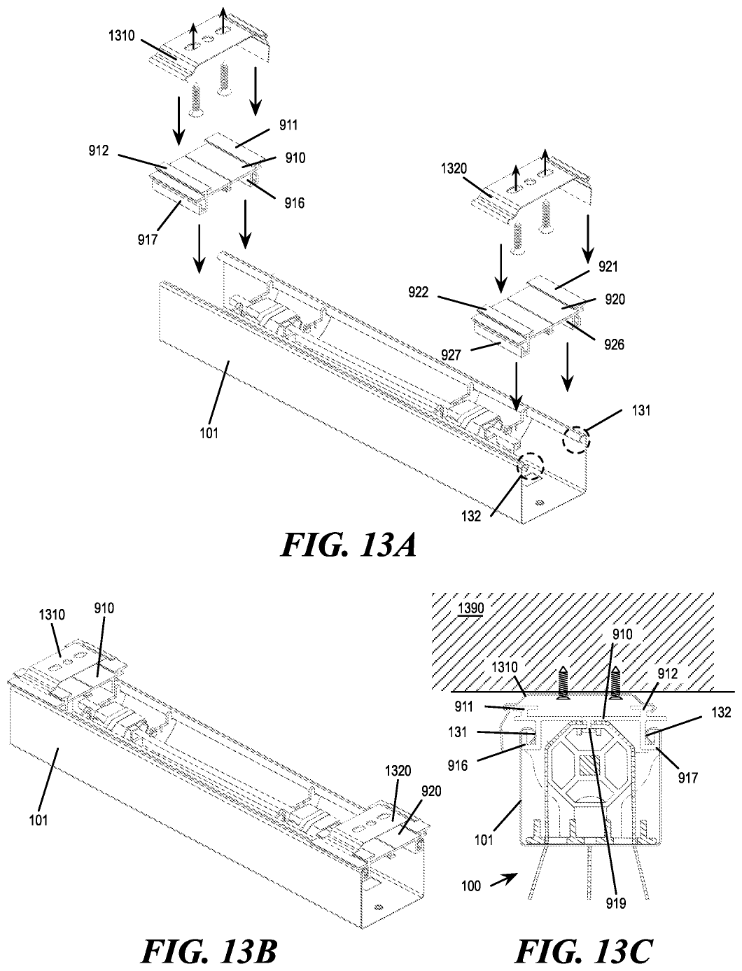

In some embodiments, the support bracket 110 is not used to mount the headpiece of the window blind to a wall. Instead, a mounting clip is used mount the window blind to a ceiling or a wall above. The mounting clip is configured to snap onto the two top rails of a railing segment (e.g., the top rails 911 and 912 of the railing segment 910). The bottom rails of the railing segments in turn support the weight of the window blind (e.g., the bottom rails 916 and 917 hooking onto the curling lips 131 and 132 of the headpiece 101 as described by reference to FIG. 10C). FIGS. 13A-C illustrate using mounting clips and railing segments to mount a window blind.

FIGS. 13A-B show the mounting clips 1310 and 1320 being mounted upward to the ceiling (not shown). The railing segments 910 and 920 are installed into the headpiece 101, e.g., by sliding the railing segments into the headpiece 101 from both ends. This allows the J-shaped bottom rails of the railing segments (e.g., the bottom rails 916 and 917 of the railing segment 910) to hook onto the curling lips 131 and 132. The installer may then mount the window blind by snaping the railing segments 910 and 920 respectively into the mounting clips 1310 and 1320. The positions of the railing segments 910 and 920 along the headpiece 101 can be adjusted (by e.g., sliding) to match the positions of the mounting clips 1310 and 1320. The mounting clips are made of materials such as stainless steel or other types of metal that can support the weight of the window blind assembly.

FIG. 13C shows a side elevation view of the installed window blind. As illustrated, the mounting clip 1310 is mounted on a wall 1390. The mounting clip 1310 is snapped onto the railing segment 920 at the flanges of the T-shaped top rails 911 and 912. One end of the mounting clip 1310 is longer than the other end. The longer end can be used to release the railing segment from the mounting clip. The J-shaped bottom rails 916 and 917 support the weight of the window blind by hooking onto the curling lips 131 and 132. The J-shaped bottom rails 916 and 917 also constrain the headpiece 101 by abutting the interior surfaces of the headpiece casing 101. The railing segment 910 also includes a supplemental bottom rail 919 that can be used to support or hold up other window blind components.

In the example of FIGS. 13A-B, railing segments with the J-shaped bottom rails are used to hook on the curling lips of the headpiece casing, and thereby support the weight of the window blind. In some other embodiments, railing segments without J-shaped bottom rails can also be used with mounting clips to mount a window blind.

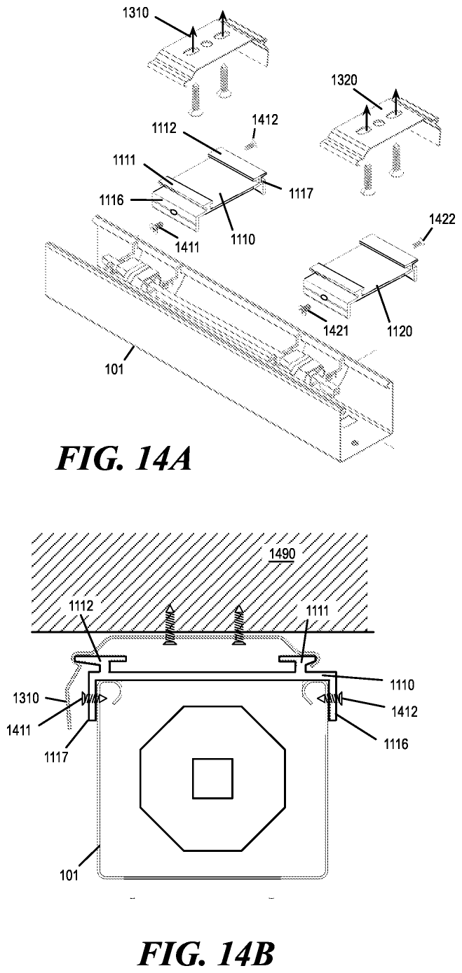

FIGS. 14A-B illustrate railing segments fastened to a headpiece casing for mounting the window blind with mounting clips. As illustrated, railing segments 1110 and 1120 (identical parts) are fastened to the headpiece casing 101, and the window blind can be installed by snapping the top rails of the railing segments 1110 and 1120 to the mounting clips 1310 and 1320. FIG. 14B shows the railing segment 1110 having bottom rails 1116 and 1117 that are configured to abut the exterior surfaces of the headpiece casing 101. The fasteners 1411 and 1412 go through drill holes in the bottom rails 1116 and 1117 to support the weight of the headpiece casing 101 and the window blind. The mounting clip 1310 snaps on to the flanges of the T-shaped top rails 1111 and 1112 to mount the window blind to the wall or ceiling 1490.

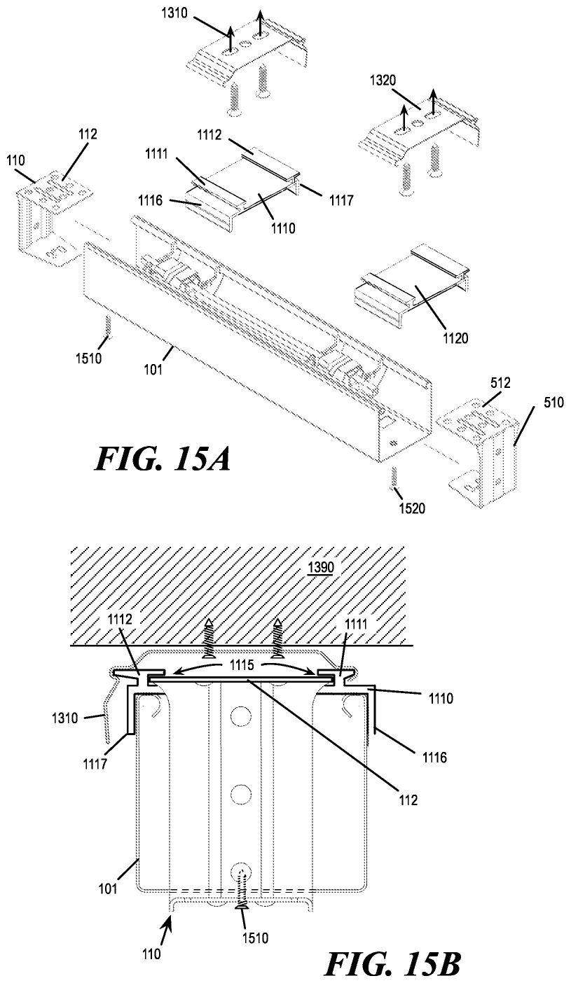

Instead of or in conjunction with fastening the railing segments 1110 and 1120 to the headpiece casing 101, support brackets can be used to bind the railing segments to the headpiece casing. In some of these embodiments, the support brackets are not directly mounted to the wall, but instead fastened to the headpiece casing of the window blind. Railing segments mated with the fastened support brackets can then be used to snap the headpiece casing into mounting clips at the ceiling. Such a railing segment can be the railing segment 1110, which has bottom rails that abut the exterior surface of the headpiece casing. FIGS. 15A-B illustrate using support brackets fastened to a headpiece casing to install a window blind to mounting clips.

As illustrated, the support brackets 110 and 510 are fastened to the headpiece 101 of the window blind (by fasteners 1510 and 1520). The railing segments 1110 and 1120 are installed into the headpiece 101. Specifically, the support brackets 110 and 510 are mated with the railing segments 1110 and 1120. The installer may then mount the window blind by snaping the railing segments 1110 and 1120 respectively into the mounting clips 1310 and 1320. The positions of the railing segments 910 and 920 along the headpiece 101 can be adjusted (by e.g., sliding) to match the positions of the mounting clips 1310 and 1320.

FIG. 15B is a side elevation view of the installed headpiece. As illustrated, the headpiece 101 is embraced by the support bracket 110 and the top plate 112 is inserted into the recess cavity 1115 of the railing segment. The support bracket 110 therefore affixes the railing segment 1110, whose bottom rails 1116 and 1117 in turn constrains the headpiece 101 by abutting its exterior surfaces. (Likewise, though not illustrated, the support bracket 510 affixes the railing segment 1120, whose bottom rails also constrains the headpiece 101 in place by abutting its exterior surfaces.) The T-shaped top rails 1111 and 1112 of the railing segment 1110 are flanged to snap into the mounting clip 1310 to mount the headpiece 101. Though not illustrated, when the support brackets are fastened to the headpiece casing, railing segments (e.g., 910) with J-shaped bottom rails that abut the interior surfaces of the headpiece casing can also be used to mount the window blind with mounting clips.

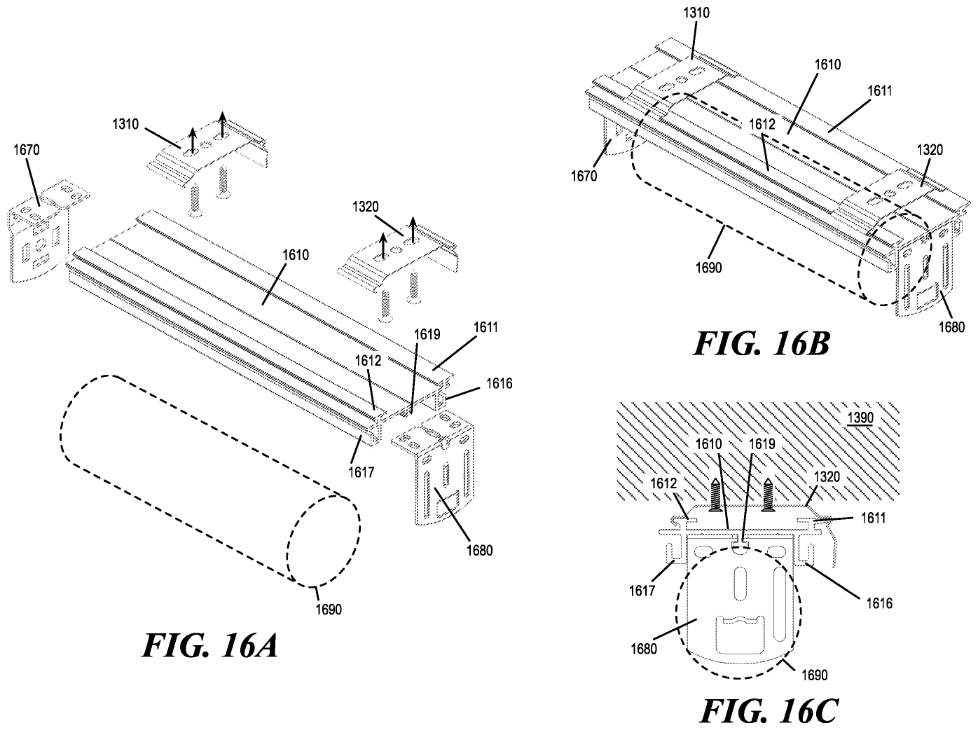

In some embodiments, a headrail that runs the length of a window blind is used for mounting. The headrail may have an identical or similar cross section as the railing segment 910, i.e., it has two top rails configured to snap into mounting clips and two or more bottom rails for supporting the weight of the window blind. FIGS. 16A-C illustrate a headrail 1610 that is used to mount a window blind 1690. The window blind 1690 may have a headpiece or casing that is similar to the headpiece 101 for cord or other mechanisms. The window blind 1690 may have a roller as a headpiece that is different than the headpiece 101.

FIGS. 16A-B show the mounting clips 1310 and 1320 being mounted upward to the ceiling (not shown). A pair of holder brackets 1670 and 1680 are installed at the two ends of the headrail 1610. The holder brackets 1670 and 1680 are used to hold up the headpiece 1690 (conceptually illustrated by a cylinder in broken lines) of a window blind. The installer may mount the window blind by snaping the headrail 1610 onto the mounting clips 1310 and 1320.

FIG. 16C shows a side elevation view of the installed window blind. As illustrated, the mounting clip 1320 is mounted on a wall 1390. The mounting clip 1320 is snapped onto the headrail 1610 at the top rails 1611 and 1612, which are T-shaped. A T-shaped supplemental bottom rail 1619 of the headrail allows the holder brackets 1680 (and 1670) to latch on the headrail 1610.

Like the railing segment 910, the headrail 1610 has J-shaped bottom rails 1616 and 1617. When the headrail 1610 is used to mount a headpiece casing such as the headpiece 101 (not illustrated), the bottom rails 1616 and 1617, like their counter parts in the railing segment 910, can be used to constrain the headpiece 101 by abutting the interior walls of the headpiece casing. Furthermore, the J-shaped bottom rails 1616 and 1617 can be used to hook on to the curling lips 131 and 132 of the headpiece casing.

When the headrail 1610 is not used to mount a headpiece with a casing (e.g., the headpiece 101), the J-shaped bottom rails 1616 and 1617 are free to be used for supporting other components or accessories of a window blind. FIGS. 17A-B illustrate latching taps 1710 and 1720 latching onto the J-shaped bottom rail 1617 for installing a façade 1700, while the T-shaped supplemental bottom rail 1619 is used to latch the holder brackets 1670 and 1680. In some embodiments, optional fasteners 1715 and 1725 may be used to further tighten the latching taps 1710 and 1720 to the J-shaped bottom rail 1617.

FIGS. 18A-B illustrate the T-shaped supplemental bottom rail 1619 and the J-shaped bottom rail 1616 being used jointly to install a Roman shade 1810. As illustrated, the J-shaped bottom rail 1616 holds up one end of the Roman shade 1810, while the T-shaped supplemental bottom rail 1619 is used to latch the holder brackets 1670 and 1680, which bracket a roller 1820 of the Roman shade 1810.

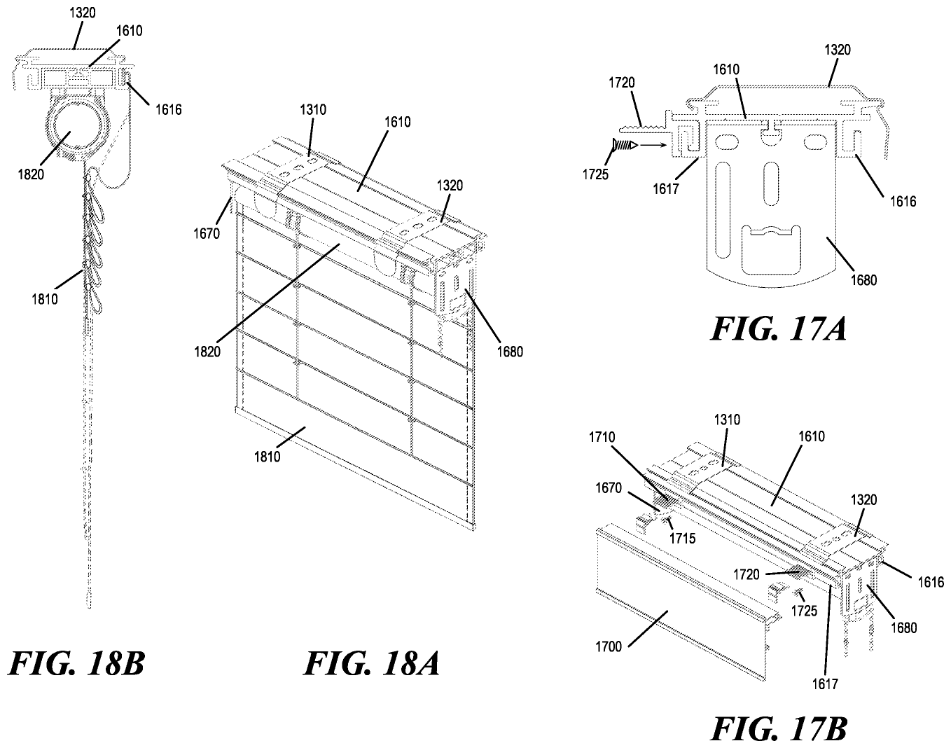

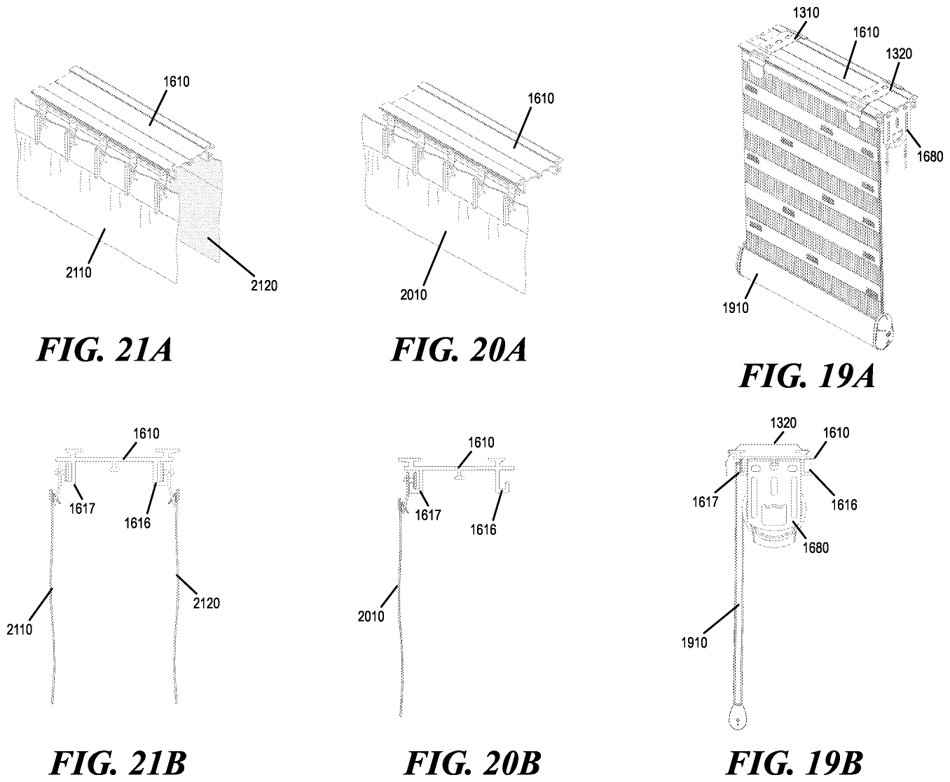

FIGS. 19A-B illustrate the J-shaped bottom rail 1617 being used to latch one end of a window blind 1910 while the holder brackets 1670 and 1680 support the roller 1920 of the window blind 1910. FIGS. 20A-B illustrate the J-shaped bottom rail 1617 being used to hang a window blind 2010 without a headpiece. FIGS. 21A-B illustrate both J-shaped bottom rails 1617 and 1618 of the headrail being used to hang window blinds 2110 and 2120. In each of the examples shown in FIGS. 17-21, the mounting clips 1310 and 1320 are mounted to the ceiling and the headrail 1610 is snapped into the mounting clips.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for mounting a window blind, the method comprising:
providing a railing device comprising:
first and second top rails; and
first and second bottom rails; and
providing a mounting clip that is configured to mount to a surface of a wall or ceiling,
wherein the mounting clip is configured to snap onto the first and second top rails of the railing device,
wherein the first and second bottom rails are configured to constrain a headpiece casing of the window blind.

2. The method of claim 1, wherein the first and second top rails are T-shaped with flanges that snap into the mounting clip.

3. The method of claim 1, wherein the first and second bottom rails are configured to abut interior surfaces of a headpiece casing of the window blind.

4. The method of claim 1, wherein the first and second bottom rails are J-shaped,

5. The method of claim 4, wherein the headpiece casing comprises curling lips, wherein the first and second bottom rails are configured to hook onto the curling lips.

6. The method of claim 4, wherein the railing device is one of two or more railing segments that are configured to slide along the headpiece casing to match a position of the mounting clip.

7. The method of claim 4, wherein the railing device is a headrail having a length that is at least half of that of the headpiece.

8. The method of claim 4, wherein the first and second bottom rails are configured to constrain the headpiece of a first type of window blinds, wherein the railing device further comprises a third bottom rail that is T-shaped and is configured to latch a holder bracket for supporting a roller of a second, different type of window blinds.

9. The method of claim 4, wherein the first bottom rail is configured to latch a component of the window blind.

10. The method of claim 1, further comprising providing a flex bracket that is configured to be fastened to an end of the headpiece casing and to mate with the railing device, wherein:
the first and second bottom rails are configured to abut exterior surfaces of the headpiece casing,
the first and second top rails of the railing device form a recess cavity that is configured to mate with the flex bracket, and
the flex bracket is C-shaped and comprises a top plate that is configured to mate with the railing device.

11. A method for mounting a window blind, the method comprising:
providing a flex bracket comprising a top plate, a middle plate, and a bottom plate that are configured to form an embrace for supporting a headpiece casing of the window blind, wherein the flex bracket is configured to be mounted to a wall surface; and
providing a railing device that is configured to constrain the headpiece casing to the flex bracket.

12. The method of claim 11, wherein the railing device comprises first and second top rails that are T-shaped and form a recess cavity that is configured to mate with the top plate of the flex bracket.

13. The method of claim 11, wherein the railing device comprises first and second bottom rails that are configured to abut exterior surfaces of the headpiece casing.

14. The method of claim 11, wherein:
the railing device comprises first and second bottom rails that are configured to abut interior surfaces of the headpiece casing,
the headpiece casing comprises curling lips, and
the first and second bottom rails are J-shaped and configured to hook onto the curling lips.

15. The method of claim 11, wherein the flex bracket is configured to be mounted to the wall through the top plate.

16. The method of claim 11, wherein the flex bracket is configured to be mounted to the wall through the middle plate.

17. A method for mounting a window blind, the method comprising:
providing a flex bracket comprising a top plate, a middle plate, and a bottom plate that are configured to form an embrace for supporting a headpiece casing of the window blind, wherein the flex bracket is configured to be mounted to a first wall surface; and
providing an adjustable arm that is configured to constrain the headpiece casing to the flex bracket, wherein the adjustable arm is fastened to the top plate of the flex bracket through a slipping groove that allows the adjustable arm to extend, retract, and swivel.

18. The method of claim 17, wherein the adjustable arm is allowed to swivel to a first position that is perpendicular to the middle plate and a second position that is parallel to the middle plate.

19. The method of claim 17, further comprising providing a spacer that is configured to mate with the flex bracket and to define a spacing between the flex bracket and a second wall surface.

20. The method of claim 19, wherein the spacer comprises a first recess cavity configured to recess the top plate of the flex bracket and a second recess cavity configured to recess the adjustable arm when the adjustable arm is at a position perpendicular to the middle plate.

21. The method of claim 17, wherein the adjustable arm is configured to swivel to a position perpendicular to the middle plate when the flex bracket is mounted to a wall surface behind the headpiece casing.

22. The method of claim 17, wherein the adjustable arm is configured to swivel to a position parallel to the middle plate when the flex bracket is mounted to a wall surface to a side of the headpiece casing.

23. The method of claim 17, wherein the adjustable arm is plastic, and the flex bracket is metallic.
